(19) United States
(12) Patent Application Publication
(10) Pub. No.: US 2007/0037686 A1
(43) Pub. Date: Feb. 15, 2007

(54) Silico-sodo-calcic glass composition for the production of substrates.

(76) Inventor: Catherine Goulas, Paris (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/555,098

(22) PCT Filed: May 7, 2004
(86) PCT No.: PCT/FR04/01132

§ 371 Date: Nov. 2, 2005

(30) Foreign Application Priority Data
May 7, 2003 (FR) 03/05588

(51) Int. Cl. C03C 3/087

(52) U.S. Cl. 501/70

(57) ABSTRACT

| | |
|---|---|
| SiO₂ | 67-75% |
| Al₂O₃ | 0.5-1% |
| ZrO₂ | 2-7% |
| Na₂O | 2-9% |
| K₂O | 4-11% |
| MgO | 0-5% |
| CaO | 5-10% |
| SrO | 5-12% |
| BaO | 0-3% |
| B₂O₃ | 0-3% |
| Li₂O | 0-2% |

The present invention relates to a glass composition intended for the manufacture of thermally stable substrates or plates that comprises the constituents given below, in the following proportions by weight: with the relationships
Na₂O+K₂O>10%
MgO+CaO+SrO+BaO>12%
and said composition having a thermal expansion coefficient between 80 and 90×10⁻⁷/° C. It also relates to the use of these glass compositions for the production of substrates, especially for emissive displays and for fire-resistant glazing.

The present invention relates to glass compositions that can be converted into a glass ribbon, especially by the <<float>> process, from which ribbon heat-resistant glass plates can be cut. These plates can be used especially for the production of substrates used in the manufacture of emissive displays, such as plasma displays, electroluminescent displays and cold-cathode displays or FEDs (Field Emission Displays), or in the manufacture of fire-resistant glazing.

The glass employed for producing such substrates is a glass belonging to the family of soda-lime-silica glasses, commonly used for forming the glazing intended for buildings or for motor vehicles. Although this type of glass is satisfactory as regards chemical resistance, flatness and the defects that it contains, the level of performance in terms of ability to undergo yellowing proves, however, to be insufficient for the intended application.

In the manufacture of emissive displays, the substrate is subjected to several treatments for the purpose of stabilizing its dimensions and for attaching a series of layers of various compounds, such as enamels, that are deposited on its surface. To attach these layers of variable thicknesses, the substrate is in general heat treated at a temperature above 550° C. In this regard, it is important to ensure that the expansion coefficient of the glass used is of the same order of magnitude as that of the compounds deposited on its surface so as to prevent the appearance of crazing. Although soda-lime-silica glass generally has a suitable expansion coefficient, its temperature withstand capability is, however, insufficient and it is necessary to place it on a ground slab to avoid any deformation during the heat treatments.

Moreover, it has been observed that substrates made of soda-lime-silica glass bearing heat-treated silver-based layers have a tendency to develop a yellow coloration. This yellowing phenomenon is attributed to the migration of Ag⁺ ions into the glass, which ions are then reduced to the form of colloidal Ag⁰ particles that absorb light in the wavelength range from 390 to 420 nanometers. The yellowing of the glass is a contributory factor in degrading the quality of the image.

The glasses used for the manufacture of fire-resistant glazing belonging to the category of borosilicate glasses. Such glasses, which exhibit good resistance to heat and heat shocks, are characterized by a relatively low expansion coefficient. As a result, the mechanical strength of this type of glass cannot be significantly improved by thermal toughening as the development of high stresses in the glass is not allowed.

Glass compositions for obtaining plates or substrates with virtually zero deformation during heat treatments of around 550 to 600° C. and capable of undergoing thermal toughening are disclosed in WO-A-96/11887. These are glass compositions having the desired properties for plasma displays, which use little or no alumina Al₂O₃ (0 to 18%), having a high content (6.5 to 20%) of zirconia ZrO₂ and an SiO₂ content not exceeding 63%.

Compositions for providing thermally stable substrates which combine alumina (0 to 5%) and zirconia (5 to 10%) are also disclosed in FR-A-2 578 550.

However, with one or other of the compositions, the glass yellowing phenomenon persists. There is therefore a need for improved glass compositions that make it possible to obtain glasses having the lowest possible degree of yellowing.

The object of the present invention is to propose a glass composition for manufacturing a plate or a substrate which exhibits improved resistance to yellowing and retains the abovementioned properties, in particular a thermal expansion coefficient α at least equivalent to that of known soda-lime-silica glasses.

The subject of the invention is a glass composition intended for the manufacture of thermally stable substrates or plates that comprises the constituents given below, in the following proportions by weight:

| | |
|---|---|
| SiO₂ | 67-75% |
| Al₂O₃ | 0.5-1% |
| ZrO₂ | 2-7% |
| Na₂O | 2-9% |
| K₂O | 4-11% |
| MgO | 0-5% |
| CaO | 5-10% |
| SrO | 5-12% |
| BaO | 0-3% |
| B₂O₃ | 0-3% |
| Li₂O | 0-2% |

with the relationships:
Na₂O+K₂O>10%
MgO+CaO+SrO+BaO>12%
and said composition having a thermal expansion coefficient between 80 and 90×10⁻⁷/° C., especially less than 85×10⁻⁷/° C., and preferably between 81 and 84×10⁻⁷/° C.

The substrates or plates obtained from the compositions according to the invention are capable of undergoing the heat treatments needed for their application, for example as a plasma display, and have a lower degree of yellowing compared with soda-lime-silica glasses. The improvement in aging of the glass, consisting in limiting the appearance of yellow coloration, is not, however, obtained to the detriment of the other properties of the glass.

The reduction in yellowing stems from the choice of a high SiO₂ content (equal or greater than 67%), a very low Al₂O₃ content (0.5 to 1%) and a low ZrO₂ content (2 to 7%). By virtue of the combination of the constituents, as results from the definition of the invention, it is possible to obtain glasses having a thermal expansion coefficient that remains the same order of magnitude as that of a conventional soda-lime-silica glass, namely between 80 and 90×10⁻⁷/° C., especially less than 85×10⁻⁷/° C., and preferably between 81 and 84×10⁻⁷/° C. measured at a temperature between 20 and 300° C.

The combination of the aforementioned constituents also makes it possible to obtain glasses having a strain point above 570° C., preferably 580° C., which temperature is at least about 70° C. higher than that of a conventional soda-lime-silica glass. It is known that the glass no longer exhibits any viscous behavior above the strain point corresponding to the temperature at which the glass has a viscosity of the order of 10^{14.5} poise. Thus, the strain point is a useful reference point for evaluating the temperature withstand capability of a glass. The strain point of the glasses according to the invention is comparable to that obtained for other known glasses for producing displays (see WO 96/11887 and FR 2 758 550).

The glasses according to the invention have in general a density at 25° C. of less than 3, preferably around 2.7, similar to that of the existing glasses used for manufacturing displays.

The glasses according to the invention are well suited to the melting techniques associated with the float process, in which the glass floats on a bath of molten metal, especially tin. They cause only very slight corrosion of the refractories, of the AZS (alumina-zirconia-silica) type, that are normally employed in this type of furnace.

The glasses according to the invention can be easily melted and converted into glass ribbon at temperatures of the same order as those used for the manufacture of a conventional soda-lime-silica glass.

Thus, they generally have a liquidus temperature T_{liq} corresponding to the melting point of the batch materials of at most 1180° C., especially between 1130 and 1170° C. These glasses also have a temperature of at least 1160° C., especially between 1160 and 1200° C. at which the viscosity η (in poise) is such that log η=3.5. For a person skilled in the art, this temperature corresponds to the ideal viscosity for forming the glass.

The compositions according to the invention have a “working range”, defined by the temperature difference T_{logη=3.5}−T_{liq} (corresponding to the temperature range allowing the glass to be melted and formed), of at least 10 to 30° C. This working range, although narrow, is sufficient for ensuring proper forming without a major risk especially in the operation of the furnace.

The role of the constituents employed in the glass composition according to the invention is defined below.

SiO₂ plays an essential role. Its content is necessarily equal to or greater than 67%, without however exceeding 75%; above this, the melting of the charge and the refining of the glass require high temperatures, which cause premature wear of the furnace refractories. Below 67% by weight of silica, the performance of the glass, especially in terms of yellowing, is reduced. The glasses that are best suited to the conditions of floating on a bath of molten metal, and have the best properties, contain between 67 and 71% SiO₂.

Alumina acts as a stabilizer. It contributes to increasing the chemical resistance of the glass and the strain point.

ZrO₂ also acts as a stabilizer. This oxide increases the chemical resistance of the glass to a certain extent and helps to increase the strain point. The percentage of ZrO₂ generally does not exceed 7% so as not to penalize the melting operation. Although this oxide is difficult to melt, it has the advantage of increasing only moderately the viscosity of the glasses according to the invention at high temperatures, unlike the other oxides such as silica or alumina. The use of the ZrO₂ makes it possible avoid introducing oxides such as B₂O₃ into these glasses or to increase the amount of alkali metal oxides, one of the effects of these oxides being to reduce the viscosity of the glass.

Alumina and zirconia fulfill quite similar roles: the sum of the Al₂O₃ and ZrO₂ contents is preferably less than 6%.

The oxides Na₂O and K₂O allow the melting point of the glasses and the viscosity at high temperatures to be maintained within the abovementioned limits. To do this, the sum of these oxides remains equal to or greater than 10%, preferably between 10 and 15%. Compared with a conventional soda-lime-silica glass, the presence of Na₂O and K₂O makes it possible for their chemical resistance, especially their hydrolytic resistance, and their resistivity to be considerably increased. When it is desired to increase the overall content of Na₂O and K₂O, it is preferable that it be the K₂O content that increases, as this allows the glass to be thinned without excessively lowering the strain point. Advantageously, the weight ratio of the Na₂O content to the K₂O content is less than or equal to 0.7.

The alkaline-earth oxides have the overall effect of raising the strain point: as a general rule, their total content, especially the total content of MgO, CaO, SrO, and BaO, is greater than 12%, preferably greater than or equal to 15%.

Above about 15%, the ability of the glasses to devitrify increases and may become incompatible with the conditions for manufacturing the glass by floating on a bath of molten metal. It is essentially CaO and MgO that allow the value of the strain point to be increased.

To maintain devitrification of the glasses within acceptable limits, the CaO and MgO weight contents do not exceed 5% and 10%, respectively.

BaO and SrO are used to increase the chemical resistance of the glass and BaO also has the effect of reducing the melting point and the viscosity at high temperatures.

Boron oxide, B₂O₃, is optional. This network-former oxide may be added to or substituted for SiO₂. It reduces the melting point of the charge and the viscosity of the glass at high temperatures. It also reduces the ability of the glass to devitrify, particularly by preventing a rise in the liquidus temperature.

Lithium oxide, Li₂O, is also optional. It may be introduced into the glass in an amount not exceeding 2% and has the effect in particular of lowering the melting point.

Overall, the melting of the glasses according to the invention remains within acceptable temperature limits provided that the sum of the SiO₂, Al₂O₃ and ZrO₂ contents remains equal to or less than 83%, preferably 80%. The term “acceptable limits” is understood to mean here that the temperature of the glass corresponding to a viscosity η, such that log η=2 does not exceed about 1560° C. and preferably 1550° C.

The preferred glass compositions according to the invention comprise the constituents below in the following proportions:

| | |
|---|---|
| SiO₂ | 67-75% |
| Al₂O₃ | 0.5-1% |
| ZrO₂ | 2-5% |
| Na₂O | 2-4% |
| K₂O | 7-11% |
| MgO | 0-2% |
| CaO | 6-10% |
| SrO | 6-12% |
| BaO | 0-2% |
| B₂O₃ | 0-3% |
| Li₂O | 0-2%. |

The glass compositions according to the invention can be used for the manufacture of heat-resistant plates, especially for forming substrates for plasma, electroluminescent or field-emission displays. These substrates may be obtained by cutting glass sheets from a continuous glass ribbon obtained by floating the glass on a bath of molten metal. They may have a glass thickness that varies from 0.5 mm to 10 mm.

These plates may also be used for the manufacture of fire-resistant glazing, again especially obtained by cutting them from a ribbon of floated glass.

The advantages afforded by the compositions according to the invention will be more fully appreciated through the illustrative examples given in Table 1 appended hereto.

Examples 1 to 4 describe glass compositions according to the invention. The glass of Example 5 corresponds to a conventional soda-lime-silica glass composition used to manufacture a glass ribbon by the float process. The glass of Example 6 is a glass sold under the name PD200 by Asahi, suitable for the production of emissive displays.

This table gives, for each example, the weight contents and the values of the properties of the glasses obtained, namely the strain point, the thermal expansion coefficient α_{25-300° C.}, b*, T_{liq}−T_{logη=3.5}, T_{logη=2} and density.

The value of b* is representative of the degree of yellowing of the glass. It is measured in the following manner:

A film of metallic silver is deposited on the surface of the glass using the “sputtering” method. The glass is then heated to 580° C. at the rate of 10° C./min, maintained at this temperature for 30 min and then cooled to room temperature at the rate of 5° C./min. The glass is immersed in an HNO₃ solution in order to remove the silver film. The chromatic coordinate b* is measured under illuminant D₆₅ taking the colorimetric reference observer described by the Commission Internationale de l'Eclairage (CIE) 1931.

The other properties were measured using methods well known to those skilled in the art.

As Examples 1 to 4 show, the degree of yellowing after heat treatment of the glasses according to the invention is markedly lower than that of the soda-lime-silica glass of Example 5 or of the display glass of Example 6.

It should be noted that the coefficient a retains a satisfactory value, of greater than 80×10⁻⁷/° C., comparable to the aforementioned reference glasses.

The strain point of the glasses according to the invention is much higher than that of the soda-lime-silica glass and is improved over the display glass.

Moreover, the glasses according to the invention are manufactured under the float process conditions without any problems, whether as regards melting in the furnace or floating on the bath of molten metal, given that the difference between the temperature T_{logη=3.5} and the liquidus temperature T_{liq} remains positive.

TABLE 1

| | Ex. 1 | Ex. 2 | Ex. 3 | Ex. 4 | Ex. 5 | Ex. 6 |
|---|---|---|---|---|---|---|
| SiO₂ | 67.5 | 67.5 | 67.5 | 67.5 | 71.4 | 58.0 |
| Al₂O₃ | 0.50 | 0.50 | 0.50 | 0.50 | 0.60 | 6.75 |
| ZrO₂ | 2 | 2 | 2 | 2 | 0 | 2.85 |
| Na₂O | 2.0 | 4.0 | 3.0 | 3.0 | 14.0 | 4.1 |
| K₂O | 10.0 | 8.0 | 10.0 | 10.0 | 0 | 6.4 |
| MgO | 0 | 0 | 0 | 0 | 4 | 2.0 |
| CaO | 9 | 9 | 8 | 10 | 9.6 | 4.95 |
| SrO | 9 | 9 | 9 | 7 | 0 | 7.05 |
| BaO | 0 | 0 | 0 | 0 | 0 | 8 |
| Strain | 592 | 584 | 586 | 586 | 505 | 581 |
| point (° C.) | | | | | | |
| α | 81.32 | 82.72 | 83.92 | 83.60 | 89.00 | 83.00 |
| (×10⁻⁷/° C.) | | | | | | |
| b* | ≦2 | ≦2 | ≦2 | ≦2 | 8.2 | 6.4 |
| T_{liq} − | ≧10 | ≧10 | ≧10 | ≧10 | 65 | 155 |
| T_{log η = 3.5} | | | | | | |
| (° C.) | | | | | | |
| T_{log η = 2} | 1559 | 1527 | 1558 | 1543 | 1450 | 1545 |
| (° C.) | | | | | | |
| Density | 2.71 | 2.71 | 2.71 | 2.70 | 2.52 | 2.76 |

1. A glass composition for the manufacture of thermally stable substrates or plates wherein the glass composition comprises the constituents below, in the following proportions by weight:

| | |
|---|---|
| SiO₂ | 67-75% |
| Al₂O₃ | 0.5-1% |
| ZrO₂ | 2-7% |
| Na₂O | 2-9% |
| K₂O | 4-11% |
| MgO | 0-5% |
| CaO | 5-10% |
| SrO | 5-12% |
| BaO | 0-3% |
| B₂O₃ | 0-3% |
| Li₂O | 0-2% |

with the relationships
Na₂O+K₂O>10%
MgO+CaO+SrO+BaO>12%
and said composition having a thermal expansion coefficient between 80 and 90×10⁻⁷/° C.

2. The glass composition as claimed in claim 1, wherein the sum of the MgO, CaO, SrO and BaO contents is greater than or equal to 15%.

3. The glass composition as claimed in claim 1, wherein the sum of the Na₂O and K₂O contents is between 10 and 15%.

4. The glass composition as claimed in claim 1, wherein the weight ratio of the Na₂O content to the K₂O content is less than or equal to 0.7.

5. The glass composition as claimed in claim 1, wherein the SiO₂ content is less than 71%.

6. The glass composition as claimed in claim 1, wherein the sum of the Al₂O₃ and ZrO₂ contents is less than or equal to 6%.

7. The glass composition as claimed in claim 1, wherein the glass composition comprises the constituents below in the following proportions by weight:

| | |
|---|---|
| SiO₂ | 67-75% |
| Al₂O₃ | 0.5-1% |
| ZrO₂ | 2-5% |
| Na₂O | 2-4% |
| K₂O | 7-11% |
| MgO | 0-2% |
| CaO | 6-10% |
| SrO | 6-12% |
| BaO | 0-2% |
| B₂O₃ | 0-3% |
| Li₂O | 0-2%. |

8. The glass composition as claimed in claim 1, wherein the glass composition has a strain point of greater than 570° C.

9. The glass composition as claimed in claim 1, wherein the glass composition has a liquidus temperature T_{liq} of at most 1180° C.

10. The glass composition as claimed in claim 1, wherein the glass composition has a viscosity corresponding to log η=3.5 at a temperature at least equal to 1160° C.

11. The glass composition as claimed in claim 1, wherein the glass composition has a viscosity corresponding to log η=2 at a temperature not exceeding 1560° C.

12. The glass composition as claimed in claim 1, wherein the glass composition has a density at 25° C. of less than 3.

13. A method for the manufacture of a substrate for a plasma-type emissive display, a luminescent display or a field-emission display comprising utilizing the glass composition as claimed in claim 1.

14. A method for the manufacture of fire-resistant glazing comprising utilizing the glass composition as claimed in claim 1.

15. The glass composition as claimed in claim 1, wherein the thermal expansion coefficient is less than 85×10⁻⁷/° C.

16. The glass composition as claimed in claim 1, wherein the thermal expansion coefficient is between 81 and 84×10⁻⁷/° C.

17. The glass composition as claimed in claim 1, wherein the glass composition has a strain point of greater than 580° C.

18. The glass composition as claimed in claim 1, wherein the glass composition has a liquidus temperature T_{liq} of between 1130 and 1170° C.

19. The glass composition as claimed in claim 1, wherein the glass composition has a viscosity corresponding to log η=3.5 at a temperature between 1160 and 1200° C.

20. The glass composition as claimed in claim 1, wherein the glass composition has a viscosity corresponding to log η=2 at a temperature not exceeding 1550° C.

21. The glass composition as claimed in claim 1, wherein the glass composition has a density at 25° C. of around 2.7.

22. The method as claimed in claim 13, wherein the method comprises starting from a glass sheet cut from a glass ribbon obtained by floating the glass on a bath of molten metal.

23. The method as claimed in claim 14, wherein the method comprises producing the fire-resistant glazing from a sheet of glass cut from a ribbon of glass obtained by floating the glass on a bath of molten metal.
